(19) United States
(12) Patent Application Publication
(10) Pub. No.: US 2020/0311217 A1
(43) Pub. Date: Oct. 1, 2020

(54) METHOD AND SYSTEM FOR IMPLEMENTING MEMORY CHANGES IN DIGITAL INTEGRATED CIRCUITS

(71) Applicant: Wipro Limited, Bangalore (IN)

(72) Inventors: JENTIL JOSE, Cochin (IN); ROJIT JACOB, FREMONT, CA (US); SHOHIN KAKKOTH, Kannur (IN)

(21) Appl. No.: 16/370,276

(22) Filed: Mar. 29, 2019

(51) Int. Cl. G06F 17/50; G06F 3/06

(52) U.S. Cl. CPC G06F 17/505; G06F 17/5054; G06F 3/0673; G06F 3/0629; G06F 3/0604

(57) ABSTRACT

A method and system for implementing memory changes in digital Integrated Circuits (ICs) includes a step of generating a plurality of memory wrappers based on a first library associated with a digital IC design requirement and a second library associated with a set of available memories. The method includes identifying at least one available memory from the set of available memories, for each of the plurality of memory wrappers, based on the associated width and depth requirement and width and depth details associated with each of the set of available memories. The method further includes managing port connections for the at least one available memory associated with each of the plurality of memory wrappers, based on the first library and the second library. The method includes validating each of the plurality of memory wrappers using a testbench generated for the digital IC design.

### TECHNICAL FIELD

This disclosure relates generally relates to the field of digital Integrated Circuits (ICs) design, and more particularly to system and method implementing memory changes in digital ICs.

### BACKGROUND

Digital Integrated circuits (ICs) designs (for example, for Application Specific Integrated Circuit (ASIC) and Field Programmable Gate Array (FPGA)) have become increasingly complex and ever evolving owing to frequent advances and changes in design software, fabrication technology, semiconductor materials, and memory cells/elements. Specifically, memory implementation in digital IC design may change frequently because of reason that may include, but are not limited to change in functional requirement due to change in First In First Out (FIFO) depth for performance improvement or due to additional number of channels, or memory regions etc; timing closure due to use of different memory types with less access times, splitting big memories to smaller ones to improve access time, choosing a different memory type for a subset of memory blocks; for FPGA platforms, all ASIC memory has to be replaced by their native FPGA memory models; for emulation platforms, memories may have to be replaced with flops; and moving from one technology node to another one, where the memory names, port names, and available width/depth options may change.

A typical digital IC may consist of 100's of memory elements and reflecting a change across all these 100 instances of memory elements when done manually, may take a lot of effort. Further, integrating memory elements or incorporating changes in memory elements requires significant amount of time and effort.

### SUMMARY

In one embodiment, a method of implementing memory changes in digital Integrated Circuits (ICs) is disclosed. In one embodiment, the method may include generating a plurality of memory wrappers based on a first library associated with a digital IC design requirement and a second library associated with a set of available memories, where each of the plurality of memory wrappers is associated with a width and a depth requirement. The method may further include identifying at least one available memory from the set of available memories, for each of the plurality of memory wrappers, based on the associated width and depth requirement and width and depth details associated with each of the set of available memories, where the second library includes the width and depth details associated with each of the set of available memories. The method may further include managing port connections for the at least one available memory associated with each of the plurality of memory wrappers, based on the first library and the second library. The method may further include validating each of the plurality of memory wrappers using a testbench generated for the digital IC design.

In another embodiment, a method of generating memory wrappers for digital ICs designs is disclosed. The method may include creating a mapping between a first library associated with a digital IC design requirement and a second library associated with a set of available memories, where each of the first library and the second library includes details of associated memory types, associated memory names, associated memory port names, associated memory port polarity, associated memory port functionality, associated memory widths and depths. The method may further include determining names for a plurality of memory wrappers using a rule created based on memory naming format used in the first library. The method may further include generating, in a hardware description language, the plurality of memory wrappers based on the mapping between the first library and the second library and the names determined for each of the plurality of memory wrappers, where each of the plurality of memory wrappers includes instantiation of at least one memory from the set of available memories.

In yet another embodiment, a system for implementing memory changes in digital ICs is disclosed. The system includes a processor and a memory communicatively coupled to the processor, where the memory stores processor instructions, which, on execution, causes the processor to generate a plurality of memory wrappers based on a first library associated with a digital IC design requirement and a second library associated with a set of available memories, where each of the plurality of memory wrappers is associated with a width and a depth requirement. The processor instructions further cause the processor to identify at least one available memory from the set of available memories, for each of the plurality of memory wrappers, based on the associated width and depth requirement and width and depth details associated with each of the set of available memories, where the second library includes the width and depth details associated with each of the set of available memories. The processor instructions cause the processor to manage port connections for the at least one available memory associated with each of the plurality of memory wrappers, based on the first library and the second library. The processor instructions further cause the processor to validate each of the plurality of memory wrappers using a testbench generated for the digital IC design.

In another embodiment, a system for generating memory wrappers for digital ICs designs is disclosed. The system includes a processor and a memory communicatively coupled to the processor, where the memory stores processor instructions, which, on execution, causes the processor to create a mapping between a first library associated with a digital IC design requirement and a second library associated with a set of available memories, where each of the first library and the second library includes details of associated memory types, associated memory names, associated memory port names, associated memory port polarity, associated memory port functionality, associated memory widths and depths. The processor instructions further cause the processor to determine names for a plurality of memory wrappers using a rule created based on memory naming format used in the first library. The processor instructions further cause the processor to generate, in a hardware description language, the plurality of memory wrappers based on the mapping between the first library and the second library and the names determined for each of the plurality of memory wrappers, where each of the plurality of memory wrappers includes instantiation of at least one memory from the set of available memories.

It is to be understood that both the foregoing general description and the following detailed description are exemplary and explanatory only and are not restrictive of the invention, as claimed.

### BRIEF DESCRIPTION OF THE DRAWINGS

The accompanying drawings, which are incorporated in and constitute a part of this disclosure, illustrate exemplary embodiments and, together with the description, serve to explain the disclosed principles.

FIG. 1 is a block diagram illustrating an exemplary system for implementing memory changes in digital Integrated Circuits (ICs) and for generating memory wrappers for digital IC designs, in accordance with an embodiment.

FIG. 2 is a functional block diagram illustrating an IC designing device configured to implement memory changes in digital ICs and to generate memory wrappers for digital IC designs, in accordance with an embodiment.

FIG. 3 illustrates a flowchart of a method for implementing memory changes in digital IC, in accordance with an embodiment.

FIG. 4 illustrates a flowchart of a method for generating memory wrappers for digital IC designs, in accordance with an embodiment.

FIG. 5 illustrates a flowchart of a method for creating a mapping between a first library and a second library, in accordance with an embodiment.

FIGS. 6A and 6B depict a first memory table, a second memory table, a first port table, and a second port table, in accordance with an exemplary embodiment.

FIG. 7 is a block diagram of an exemplary computer system for implementing embodiments.

### DETAILED DESCRIPTION

Exemplary embodiments are described with reference to the accompanying drawings. Wherever convenient, the same reference numbers are used throughout the drawings to refer to the same or like parts. While examples and features of disclosed principles are described herein, modifications, adaptations, and other implementations are possible without departing from the spirit and scope of the disclosed embodiments. It is intended that the following detailed description be considered as exemplary only, with the true scope and spirit being indicated by the following claims. Additional illustrative embodiments are listed below.

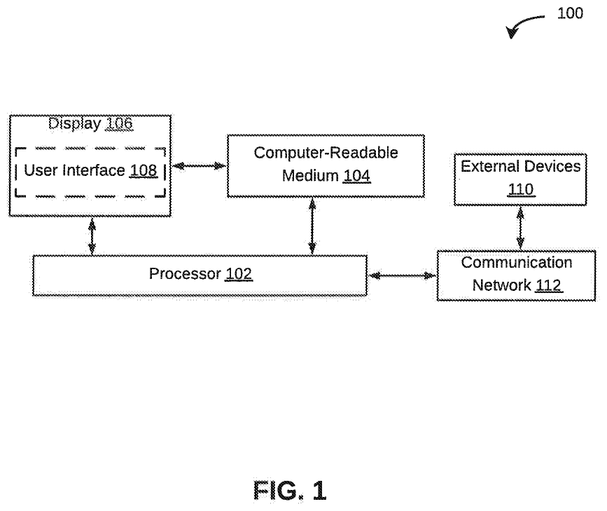

Referring now to FIG. 1, an exemplary system 100 for implementing memory changes in digital Integrated Circuits (ICs) and for generating memory wrappers for digital IC designs is illustrated, in accordance with an embodiment. Examples of digital ICs may include, but are not limited to for Application Specific Integrated Circuit (ASIC) and Field Programmable Gate Array (FPGA). As will be appreciated, the system 100 may be implemented in at least one of a first digital IC macro or a second digital IC macro in order to implement memory changes in a digital IC and generate a plurality of memory wrappers for the digital IC designs. The first digital IC macro may be associated with an ASIC and the second digital IC macro may be associated with an FPGA. Further, the system 100 may be implemented in an IC designing device (not shown in FIG. 1). The IC designing device may be configured to implement memory changes in digital ICs and to generate memory wrappers for digital IC designs. Examples of the IC designing device may include, but are not limited to a server, a desktop, a laptop, a notebook, a netbook, a tablet, a smartphone, a mobile phone, or any other computing device.

The system 100 may include a processor 102, a computer-readable medium 104 (for example, a memory), and a display 106. The computer-readable storage medium 104 may store instructions that, when executed by the processor 102, may cause the processor 102 to implement memory changes in the digital ICs and generate memory wrappers for the digital IC designs. The computer-readable storage medium 104 may also store various data (for example, a first library, a second library, a first memory table, a second memory table, and the like) that may be captured, processed, and/or required by the system 100. The system 100 may interact with a user via a user interface 108 accessible via the display 106. The system 100 may also interact with one or more of external devices 110 over a communication network 112 for sending or receiving various data. The external devices 110 may include, but are not be limited to a remote server, a digital device, or another computing system. The system 100 may be adapted to exchange data with other components or service providers using the communication network 112.

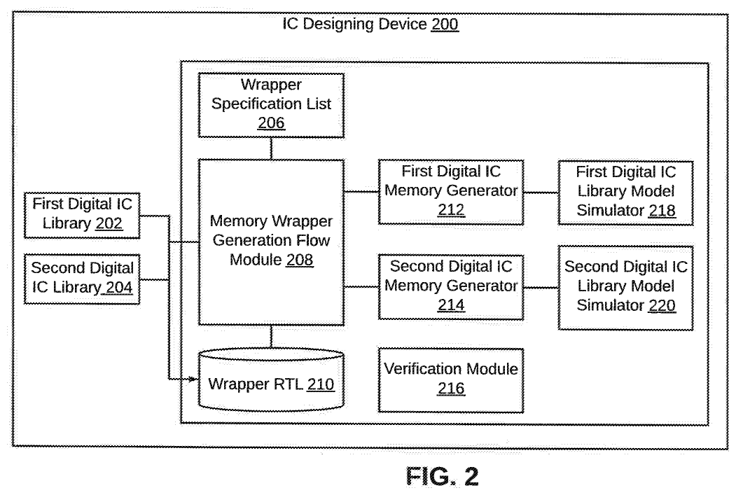

Referring now to FIG. 2, a functional block diagram illustrating an IC designing device 200 configured to implement memory changes in digital ICs and to generate memory wrappers for digital IC designs is illustrated, in accordance with an embodiment. The digital IC designs may employ a hardware description language (HDL). The IC designing device 200 may include a first digital IC library 202, a second digital IC library 204, a wrapper specification list 206, a memory wrapper generation flow module 208, a wrapper Register-Transfer Level (RTL) 210, a first digital IC memory generator 212, a second digital IC memory generator 214, a verification module 216, a first digital IC library model simulator 218, and a second digital IC library model simulator 220. As will be appreciated by those skilled in the art, all such aforementioned modules 202-220 may be represented as a single module or a combination of different modules. Moreover, as will be appreciated by those skilled in the art, each of the modules 202-220 may reside, in whole or in parts, on one device or multiple devices in communication with each other.

Each of the first digital IC library 202, the first digital IC memory generator 212, and the first digital IC library model simulator 218 may be associated with an ASIC and each of the second digital IC library 204, the second digital IC memory generator 214, the second digital IC library model simulator 220 may be associated with an FPGA.

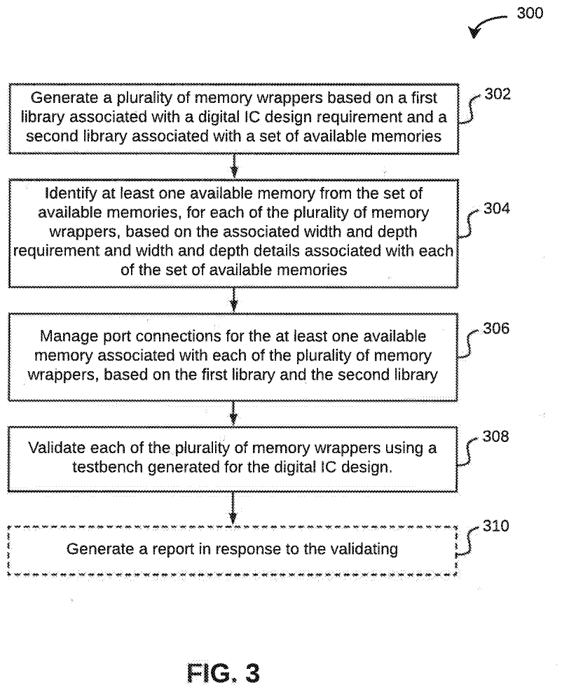

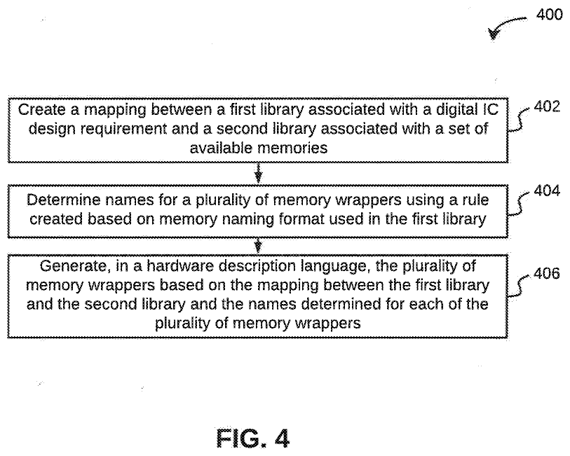

The wrapper specification list 206 may be a text file that may include a list of required memories in a digital IC design, the type of each of the required memory, or memory width and memory depth associated with each of the required memories. The wrapper specification list 206 may be updated by a memory designing team and subsequently the IC designing device 200 may generate additional memories and an additional memory wrappers, added by the memory designing team. This has been explained in detail in conjunction with FIG. 3 and FIG. 4.

The wrapper specification list 206 is further communicatively coupled to the memory wrapper generation flow module 208. The memory wrapper generation flow module 208 may include a memory wrapper tool (not shown in FIG. 2) that may receive the text file from the memory wrapper generation flow module 208. Further, for each of the required memories included in the text file, the memory wrapper tool may access details related to available memories in one of the first digital IC library 202 and the second digital IC library 204, based on the type of digital IC design. By way of an example, if the digital IC design is that for an ASIC, then the details related to available memories may be accessed from an ASIC library. Additionally, the memory wrapper tool may select the best suited available memory from the first digital IC library 202 and the second digital IC library 204. The memory wrapper tool further integrates the available memories accessed from one of the first digital IC library 202 and the second digital IC library 204 as a memory wrapper (or an RTL wrapper). It should be noted that the memory wrapper tool may automatically generate internal signals connections between sub memories inside the memory wrapper. The sub memories may be required, when a required memory of a particular width and depth may not be available in one or more of the first digital IC library 202 and the second digital IC library 204. In this case the memory wrapper tool may select smaller memories and assembles the smaller memories to meet the memory requirements. This is further explained in detail in conjunction with FIG. 3 and FIG. 4.

The memory wrapper generation flow module 208 may further be communicatively coupled to the wrapper RTL 210 which may include memory models associated with each of the first IC design (for example, ASIC) and the second IC design (for example, FPGA). The wrapper RTL 210 may generate required port connections between the memory models (associated with the first digital IC or the second digital IC) and input and output ports of the memory wrapper. The wrapper RTL 210 may include an address decoding logic within the memory wrapper, when one or more memories within the memory wrapper may be split by depth. Appropriate memory model for the first digital IC design vs the second digital IC design may be selected based on a Verilog defines statement.

The memory wrapper generation flow module 208 may further be communicatively coupled to the first digital IC memory generator 212, which may be a software tool associated with memories associated with the first digital IC (for example, memory for ASIC). The software tool may further be specific to a vendor providing these memories. The memory wrapper generation flow module 208 may generate a command script that may be used as an interface to the first digital IC memory generator 212. When the command script is executed, the first digital IC memory generator 212 may be invoked to generate the first digital IC memory model (for example, ASIC memory models). In an embodiment, a user may execute the command script to generate the first digital IC memory model. The first digital IC memory generator 212 may share the first digital IC memory model with the first digital IC library model simulator 218.

The first digital IC library model simulator 218, after receiving the first digital IC memory model, may use the first digital IC memory model in simulation based verification of the first IC design. For simulation based verification, the first digital 1C library model simulator 218 may receive timing models, Design For Test (DFT) models (i.e., DFT design for testing), and specification of the first digital IC memory model, which are generated by the first digital IC memory generator 212.

The memory wrapper generation flow module 208 may further be communicatively coupled to the second digital IC memory generator 214, which may be a software tool associated with memories associated with the second digital IC (for example, memory for FPGA). The software tool may further be specific to a vendor providing these memories. The memory wrapper generation flow module 208 may generate a command script that may be used as an interface to the second digital IC memory generator 214. When the command script is executed, the second digital IC memory generator 214 may be invoked to generate the second digital IC memory model (for example, FPGA memory models). In an embodiment, a user may execute the command script to generate the second digital IC memory model. The second digital IC memory generator 214 may share the second digital IC memory model with the second digital IC library model simulator 220.

The second digital IC library model simulator 220, after receiving the second digital IC memory model, may use the second digital IC memory model in simulation based verification of the second IC design. For simulation based verification, the second digital IC library model simulator 220 may receive timing models, DFT models, and specification of the second digital IC memory model, which are generated by the second digital IC memory generator 214.

Once a memory wrapper has been generated (either for the first digital IC design or the second digital IC design), the verification module 216 may be adapted to verify the memory wrapper using a testbench. This is further explained in detail in conjunction with FIG. 3 and FIG. 4.

The modules within the IC designing device 200 may be connected using wireless or wired communication protocols, which may include, but are not limited to Serial Advanced Technology Attachment (SATA), Integrated Drive Electronics (IDE), IEEE-1394, Universal Serial Bus (USB), fiber channel, Small Computer Systems Interface (SCSI), Simple To Design (STD) Bus, Recommended Standard (RS)-232, RS-422, RS-485, I2C, Serial Peripheral Interface (SPI), Microwire, 1-Wire, IEEE 1284, Intel Quick Path Interconnect, InfiniBand, or Peripheral Component Interconnect Express (PCIe) etc.

Referring now to FIG. 3, a flowchart of a method 300 for implementing memory changes in digital ICs is illustrated, in accordance with an embodiment.

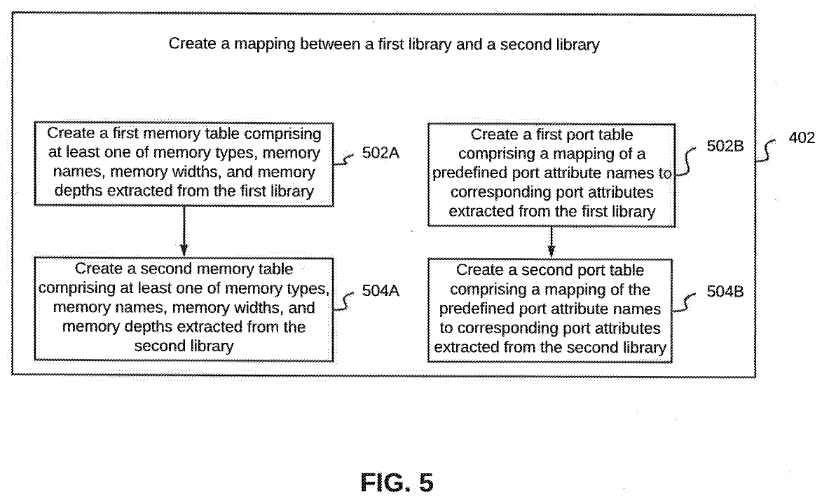

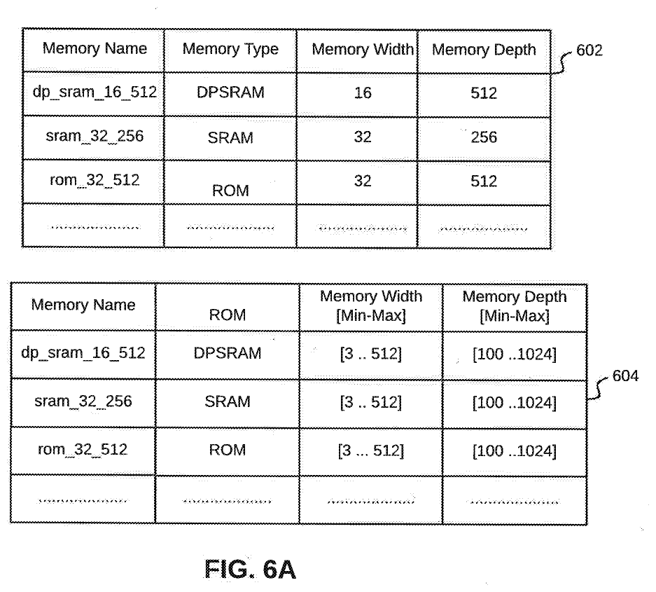

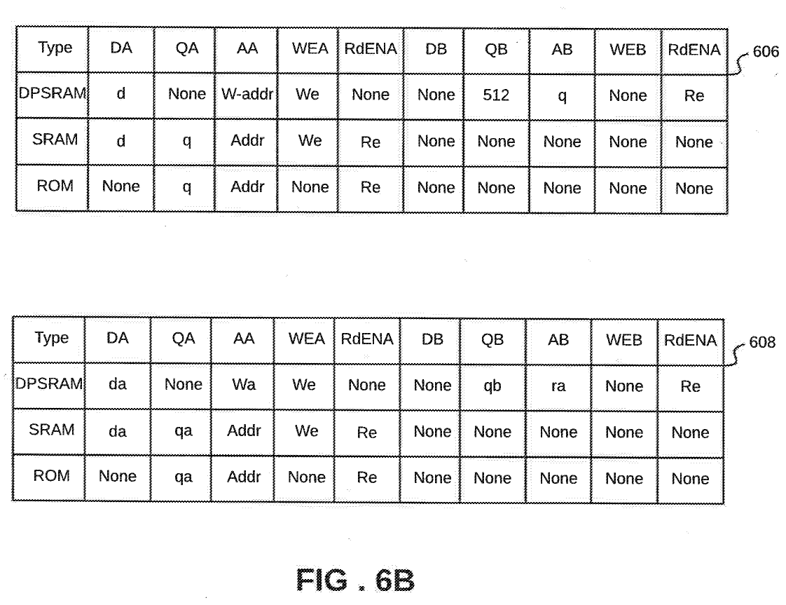

At step 302, the IC designing device 200 may generate a plurality of memory wrappers based on a first library (for example, the first digital IC library 202) associated with the digital IC design requirement and the second library (for example, the second digital IC library 204) associated with a set of available memories. Each of the plurality of memory wrappers is associated with a width and a depth requirement. Each of the first library and the second library include details of associated memory types, associated memory names, associated memory port names, associated memory port polarity, associated memory port functionality, associated memory widths and depths. In other words, the first library includes following details for memory required in the digital IC design: memory types, memory names, memory port names, memory port polarity, memory port functionality, and memory widths and depths. Similarly, the second library includes following details for available memories: memory types, memory names, memory port names, memory port polarity, memory port functionality, and memory widths and depths. In an embodiment, the set of available memories may include different memory modules with varying minimum and maximum values of the width and the depth. These details may be included in the second library. Generating the plurality of memory wrappers include creating a mapping between the first library and the second library. Creating the mapping is further explained in detail in conjunction with FIG. 5 and FIGS. 6A and 6B.

For each of the plurality of memory wrappers, at step 304, the IC designing device 200 may identify one or more available memory from the set of available memories, based on the associated width and depth requirement and width and depth details associated with each of the set of available memories. In other words, for a given memory requirement in a memory wrapper, width and depth details associated with the set of available memories is accessed. Based on this, one or more available memories from the set of available memories identified, such that, width and depth associated with one or more available memories match with the memory requirements. Thus, the IC design device 200 may automatically select a list of memories to pack the width and depth of the plurality of memory wrappers.

Identifying the one or more available memories from the set of available memories for a memory wrapper may include implementing one predefined width rules and one or more predefined depth rules on the set of available memories. One or more of a predefined width rule and a predefined depth rule may include selecting an available memory with closest width and depth for implementation, when an exact match of width and depth is not available in the second library. By way of an example, a 15-bitwidth memory may be implemented using a 16-bitwidth memory. The unused data bit (i.e., 16th bit) may be tied zero for the input data bits. The unused output data bit (i.e., 16th bit) may be left open.

One or more of a predefined width rule and a predefined depth rule may further include using two available memories with lower widths to create the required width, when an exact match of width is not available in the second library. In this case, the IC designing device 200 also generates port connections of address, data and control signals correctly for the available memories. By way of an example, a 48-bitwidth memory may be created by parallelly assembling three 16-bit memories. To achieve this, the data bus wires are split and connected among the three 16 bit memories.

One or more of a predefined width rule and a predefined depth rule may further include using an iterative procedure by filling width of the memory wrapper with best of widths available in the second library, until residue width of the memory wrapper is 0, when an exact match of width is not available in the second library.

One or more of a predefined width rule and a predefined depth rule may further include using two or more available memories with lower depth to create a required depth of a memory wrapper, when an exact match of the required depth is not available in the second library. In this case, the IC designing device 200 may generate the port connections of address, data and control signals correctly for the two or more available memories. The IC designing device 200 may also generate an address decoding logic in HDL that enables individual available memories according to read address/write address input.

When an exact match for the required depth is not available in the second library, and the second library only includes memories which have depth that are closer to ½, ¼, and ⅛ of the required depth, the predefined depth rule may include taking a cost based decision to select the memories that optimize the cost, i.e., minimize the overall wastage (non-utilized address). In an embodiment, while deciding the composition of the memory wrapper using smaller widths and depths, user provided directives in a test file may be used to restrict the widths/depths/types to a subset of memory widths/depths/types available in the second library.

For the depth of a memory wrapper, the IC design device 200 may search the depth splits (from 0 to 16) and further determine the best suited depth split for the memory wrapper. The IC designing device 200 may instantiate each of the set of available memories, width wise and depth wise, and may generate connections. The user may specify the width split, the depth splits, and the type of memory module to be used, based on a constraint file. By way of an example the constraint file name may be ‘<wrapper_name>.const’. The IC designing device 200 may use exact type, subtype, width and, depth specified to implement in each of the plurality of memory wrapper. When the plurality of wrappers may be generated, a set of Verilog parameters may be added to explain the set of key attributes. Further, a generic Verilog based test bench may be designed that may adapt itself based on the set of Verilog parameters. This is further explained in detail.

At step 306, the IC designing device 200 may manage port connections for the one or more available memories associated with each of the plurality of memory wrappers, based on the mapping between the first library and the second library. In an embodiment, the ports of a given memory wrapper of the plurality of memory wrappers and one or more available memories selected form the second library may be connected based on one or more of the following steps:
a) Check types of ports of a memory wrapper and the type of ports of available memories in the second library;
b) Check whether the width of the memory wrapper and the available memory is same or not;
c) When the width of the memory wrapper and the available memory is the same, do direct connection;
d) When the width of the memory wrapper and the available memory is not same, determine the difference and tie ‘0’ on unwanted bits;
e) When the type of ports of the memory wrapper and the type of ports of the available memory are not same, such that, one port is Bit Enable (BITEN) and the other port is Byte Enable (BYTEN), then perform BITEN to BYTEN conversion; and
f) When the type of ports of the memory wrapper and the type of ports the available memory are different, such that, one port is Read Enable (RdEn), Write Enable (WrEn), use RdEn/WrEn to EN/R_W conversion.

In an embodiment, mismatch between ports of a memory wrapper and available memory ports may be addressed during design. To this end, port connections and manipulations may be performed using one or more of the following steps:
a) If width of the available memory is higher than width of a memory wrapper, the memory wrapper generation flow module 208 may tie 0 the unused input bits Data Input (DATAIN), BITEN and BYTEN.
b) If the depth of the available memory is higher than the depth of the memory wrapper, higher address bits a tie0 of in address inputs.
c) If the memory wrapper is BITEN based and the available memory is BYTEN based, then 8 BITEN may be OR-ed to generate BYTEN,
d) If the memory wrapper is BYTEN based and the memory is BITEN based, then 1 BYTEN may be shared for 8 BITENs.
e) If same ports are available in the available memory, then unmanaged ports (for example—DFT ports, power control ports) may be connected by the memory wrapper generation flow module 208
f) In some cases, the available memory port has to be tied 0 (for example—BIST ports), in those cases give constants in a wrapper_ports.list. For example, TIE0 and TIE1.
g) For unmanaged ports (for example, DFT, power) a user may specify the width in wrapper ports.list and macro_lib.list as value=<port_name >[Size].

In order to implement a memory wrapper with required width and depth using available memories in a memory compiler library, for a width split, one or more of the following steps are performed:
a) Search through the list of available memories in the second library to determine an available memory that has the closest width match and the same type as the memory wrapper.
b) Determine the difference in cumulative width and search again for an available memory that has closest width as the difference between cumulative width and the required width.
c) Repeat steps a) and b) till the cumulative width may be nearly equal to the required width.
d) Print the memory wrapper.
e) Print the ports.
f) Print signal declarations.
g) Print connections.
h) Print the available memory instances.
i) Print port connections.

In a similar manner, for a depth split, one or more of the following steps are performed:
a) When the depth split=1, search for an available memory whose depth may be closest to the required depth of the memory wrapper.
b) Find minimal error in depth.
c) Set depth split=depth_split/2
d) Find minimal error.
e) Repeat steps c and d till the depth split= 1/16.
f) Select the depth split with minimal error.

In an embodiment, when a flop based memory is required in an ASIC design, the memory wrapper may implement the available memory using flipflops for ASIC implementation and BLOCKRAMS during FPGA implementation.

At step 308, the IC designing device 200 may validate each of the plurality of memory wrappers using a testbench generated for the digital IC design. The testbench may be designed to verify each of the plurality of memory wrappers that may be generated. The testbench may generate write and read back patterns to test the plurality of memory wrappers. Moreover, the plurality of memory wrappers may differ from project to project, in terms of the plurality of port attributes which may include wrapper names, port names, types, width, depth or the like. Hence, the plurality of port attributes may be given to the testbench for validation. Additionally, the verification of the plurality of attributes may be done using a set of Verilog defines inside the plurality of memory wrappers. It should be noted that the testbench may receive the plurality of attributes of each of the plurality of memory wrappers through the Verilog defines.

Thereafter, at step 310, the IC designing device 200 may generate a report in response to the validating. In an embodiment, after validating the plurality of attributes, the plurality of memory wrappers generation and simulation may be consolidated in a text file as a report. In one example, the report may include results of validating each of the plurality of memory wrappers.

Referring now to FIG. 4, a flowchart of a method 400 for generating memory wrappers for digital IC designs is illustrated, in accordance with an embodiment. At step 402, the IC designing device 200 may create a mapping between a first library associated with the digital IC design requirement and a second library associated with the set of available memories. Each of the first library and the second library includes details of associated memory types, associated memory names, associated memory port names, associated memory port polarity, associated memory port functionality, associated memory widths and depths. This is further explained in detail in conjunction with FIG. 5.

The mapping between the first library and the second library may be created, as memory types used in the digital IC RTL design implementations may differ from memory types that may supported by the digital IC memory vendor (the set of available memories).

With regards to memory names, an equivalent memory functionality may have two different module type names used in the digital IC RTL design and the digital IC vendor's memory model. This may lead to problems when the digital IC design migrates from one memory vendor to another, because the digital IC design RTL may have to be edited manually in multiple places to change the memory definitions.

With regards to memory port names, a same functionality port may have different name in the digital IC RTL design and the digital IC vendor's memory model. This may cause a lot of manual edit work to change the port names in the digital IC RTL design, for example, during memory migration to another digital IC vendor's memory model.

With regards to memory port polarity, the polarity of the memory control ports may not be the same in the digital IC design RTL and the digital IC vendor's memory model. In this scenario, logic—NOT gates may have to be added to correct the polarity of the control signal. However, the digital IC RTL design may have so many memories instantiated, thus this may require considerable effort.

With regards to memory port functionality, the functional definition of the digital IC memory control ports may differ. For example, a control signal pair (Read_enable, Write_enable) versus control pair—(chip_enable and R_W). In such scenarios, logic circuits may be implemented to translate functional definition of signals in the digital IC RTL design to digital IC vendor's memory model. This may have to be done on a per memory instance basis, which may require considerable effort. At step 404, the IC designing device 200 may determine names for a plurality of memory wrappers using a rule created based on memory naming format used in the first library. The existing digital IC RTL design may include a legacy code, thus the IC designing device 200 may use the plurality of memory wrapper instead of available memory. For this, digital IC RTL design may be required to be edited one time. In order to reduce the effort of such one-time editing to the digital IC RTL design, the name of each of the plurality of memory wrappers may be defined as a computed module name. In other words, a user may define a rule for creating the name of each of the plurality of memory wrappers in accordance with the individual project naming guidelines and requirements. The memory types, the memory width, and the memory depth may be a variable. Hence, by using these variables, a user may define the name style. For example, Name=sram_$widthx$depth

By way of an example, for creating the name of a memory wrapper, a rule may be ‘sram_$widthx$depth_w’. Hence, when the width of the memory may be 32 and the depth of the memory may be 512 then the computed memory name may be sram_32×512_w. Hence, the computed module name may allow to adopt the memory wrapper tool seamlessly to the digital IC manufacturing company, since the naming convention is flexible. In an embodiment, each memory name in the first library may be appended with an identifier. The identifier may enable an automated script to determine names for the plurality of memory wrappers based on the defined rule.

At step 406, the IC designing device 200 may generate, in a hardware description language, the plurality of memory wrappers based on the mapping between the first library and the second library and the names determined for each of the plurality of memory wrappers. In an embodiment, the digital IC RTL design implementations may be implemented in the plurality of memory wrapper RTL description. For a unique digital IC project, the memory type list and port list per memory may be standardized for the plurality of memory wrappers. The digital IC designs instantiate the plurality of memory wrapper in the digital IC RTL instead of the digital IC vendor memory models.

Moreover, inside each of the plurality of memory wrappers, the required digital IC memory models may be instantiated and, necessary logic circuits and wirings may be implemented which may be transparent to a digital IC RTL design team. Moreover, during the event of the digital IC memory vendor migration (i.e.—change of digital IC memory vendor), the digital IC RTL design may remain same without any change required to be made, which may avoid a lot of manual effort.

Referring now to FIG. 5, a flowchart of a method for creating 402 a mapping between a first library and a second library is depicted, in accordance with an embodiment. The first library and the second library have been explained in detail in conjunction with FIG. 3 and FIG. 4. At step 502A, a first memory table that includes one or more of memory types, memory names, memory widths, and memory depths extracted from the first library, may be created. At step 504A, a second memory table that includes one or more of memory types, memory names, memory widths, and memory depths extracted from the second library, may be created. The first and the second memory tables may be used by the IC designing device 200 to create a mapping between memory types, memory names, memory widths, and memory depths as included in the first library and the second library. This is further explained in detail in conjunction with an exemplary embodiment given in FIG. 6A.

In an alternate embodiment, the step 402 of creating the mapping may include, creating, at step 502B, a first port table that includes a mapping of predefined port attribute names to corresponding port attributes extracted from the first library. The step 402 of creating the mapping may further include, at step 502B, creating a second port table that includes a mapping of the predefined port attribute names to corresponding port attributes extracted from the second library. The first and the second port tables may be used by the IC designing device 200 to bring a uniformity between port attributes used in the first library and the second library. This is further explained in detail in conjunction with an exemplary embodiment given in FIG. 6B.

Referring now to FIGS. 6A and 6B, a first memory table 602, a second memory table 604, a first port table 606, and a second port table 608 are depicted, in accordance with an exemplary embodiment. The first memory table 602 may include memory types, a memory names, memory widths, and memory depths extracted from the first library. By way of an example, in the second row, the memory name may be ‘dp_sram_16_512’, the memory type may be Dual Port Static Random Access Memory (DPSRAM), the memory width may be 16 bit, and the memory depth may be 512 MB.

In a similar manner, the second memory table 604 may include the memory name, the memory type, a memory width range, and a memory depth range as extracted from the second library. By way of an example, in the first row, the memory name may be ‘dp_sram_16_512’, the memory type may be DPSRAM, the memory width range may be 3 to 512, and the memory depth range may be 100 to 1024.

Referring now to FIG. 6B, in the first port table 606 the predefined port attribute names include data input (DA), data output (QA), address input (AA), write enable (WEA), and a read enable (RdENA) for the port A and a DB, a QB, an AB, WEB, and a RdENB for the port B. These predefined port attribute names are mapped to corresponding port attribute names extracted from the first library. By way of an example, in the second row of the first port table 606, the type of the memory is DPSRAM. For the first port of the DPSRAM, port attribute name for data input is ‘d,’ since the DPSRAM does not have the data output, this attribute field is represented as ‘none,’ the address input may be ‘W-addr,’ the write enable may be ‘we,’ and since the DPSRAM does not have the read enable, hence this attribute field is represented as ‘none.’ It may be apparent that for memory types in rows 3 and 4, since these memories are single port memories, the column for port attributes names of the second port are empty. In a similar manner, the second port table 608 may include mapping of the predefined port attribute names to corresponding port attribute names extracted from the second library.

As will be also appreciated, the above described techniques may take the form of computer or controller implemented processes and apparatuses for practicing those processes. The disclosure can also be embodied in the form of computer program code containing instructions embodied in tangible media, such as floppy diskettes, solid state drives, CD-ROMs, hard drives, or any other computer-readable storage medium, where, when the computer program code is loaded into and executed by a computer or controller, the computer becomes an apparatus for practicing the invention. The disclosure may also be embodied in the form of computer program code or signal, for example, whether stored in a storage medium, loaded into and/or executed by a computer or controller, or transmitted over some transmission medium, such as over electrical wiring or cabling, through fiber optics, or via electromagnetic radiation, where, when the computer program code is loaded into and executed by a computer, the computer becomes an apparatus for practicing the invention. When implemented on a general-purpose microprocessor, the computer program code segments configure the microprocessor to create specific logic circuits.

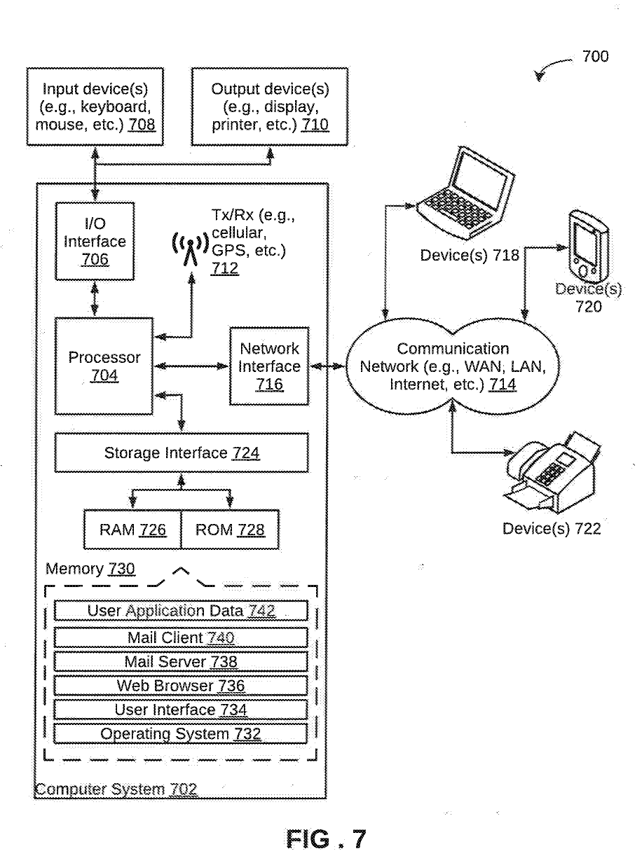

Referring now to FIG. 7, a block diagram of an exemplary computer system 702 for implementing various embodiments is illustrated. Computer system 702 may include a central processing unit (“CPU” or “processor”) 704. Processor 704 may include at least one data processor for executing program components for executing user or system-generated requests. A user may include a person, a person using a device such as such as those included in this disclosure, or such a device itself. Processor 704 may include specialized processing units such as integrated system (bus) controllers, memory management control units, floating point units, graphics processing units, digital signal processing units, etc. Processor 704 may include a microprocessor, such as AMD® ATHLON® microprocessor, DURON® microprocessor OR OPTERON® microprocessor, ARM's application, embedded or secure processors, IBM® POWERPC®, INTEL'S CORE® processor, ITANIUME processor, XEON® processor, CELERON® processor or other line of processors, etc. Processor 704 may be implemented using mainframe, distributed processor, multi-core, parallel, grid, or other architectures. Some embodiments may utilize embedded technologies like application-specific integrated circuits (ASICs), digital signal processors (DSPs), Field Programmable Gate Arrays (FPGAs), etc.

Processor 704 may be disposed in communication with one or more input/output (I/O) devices via an I/O interface 706. I/O interface 706 may employ communication protocols/methods such as, without limitation, audio, analog, digital, monoaural, RCA, stereo, IEEE-1394, serial bus, universal serial bus (USB), infrared, PS/2, BNC, coaxial, component, composite, digital visual interface (DVI), high-definition multimedia interface (HDMI), RF antennas, S-Video, VGA, IEEE 802.n/b/g/n/x, Bluetooth, cellular (for example, code-division multiple access (CDMA), high-speed packet access (HSPA+), global system for mobile communications (GSM), long-term evolution (LTE), WiMax, or the like), etc.

Using I/O interface 706, computer system 702 may communicate with one or more I/O devices. For example, an input device 708 may be an antenna, keyboard, mouse, joystick, (infrared) remote control, camera, card reader, fax machine, dongle, biometric reader, microphone, touch screen, touchpad, trackball, sensor (for example, accelerometer, light sensor, GPS, gyroscope, proximity sensor, or the like), stylus, scanner, storage device, transceiver, video device/source, visors, etc. An output device 710 may be a printer, fax machine, video display (for example, cathode ray tube (CRT), liquid crystal display (LCD), light-emitting diode (LED), plasma, or the like), audio speaker, etc. In some embodiments, a transceiver 712 may be disposed in connection with processor 714. Transceiver 712 may facilitate various types of wireless transmission or reception. For example, transceiver 712 may include an antenna operatively connected to a transceiver chip (for example, TEXAS® INSTRUMENTS WILINK WL12860 transceiver, BROADCOM® BCM45501UB8® transceiver, INFINEON TECHNOLOGIESO X-GOLD 618-PMB9800® transceiver, or the like), providing IEEE 802.6a/b/g/n, Bluetooth, FM, global positioning system (GPS), 2G/3G HSDPA/HSUPA communications, etc.

In some embodiments, processor 704 may be disposed in communication with a communication network 714 via a network interface 716. Network interface 716 may communicate with communication network 714. Network interface 716 may employ connection protocols including, without limitation, direct connect, Ethernet (for example, twisted pair 50/500/5000 Base T), transmission control protocol/internet protocol (TCP/IP), token ring, IEEE 802.11a/b/g/n/x, etc. Communication network 714 may include, without limitation, a direct interconnection, local area network (LAN), wide area network (WAN), wireless network (for example, using Wireless Application Protocol), the Internet, etc. Using network interface 716 and communication network 714, computer system 702 may communicate with devices 718, 720, and 722. These devices may include, without limitation, personal computer(s), server(s), fax machines, printers, scanners, various mobile devices such as cellular telephones, smartphones (for example, APPLE® IPHONE® smartphone, BLACKBERRY® smartphone, ANDROIDS based phones, etc.), tablet computers, eBook readers (AMAZONS KINDLE® ereader, NOOK® tablet computer, etc.), laptop computers, notebooks, gaming consoles (MICROSOFT® XBOX® gaming console, NINTENDO® DS® gaming console, SONY® PLAYSTATION® gaming console, etc.), or the like. In some embodiments, computer system 702 may itself embody one or more of these devices.

In some embodiments, processor 704 may be disposed in communication with one or more memory devices (for example, RAM 726, ROM 728, etc.) via a storage interface 724. Storage interface 724 may connect to memory 730 including, without limitation, memory drives, removable disc drives, etc., employing connection protocols such as serial advanced technology attachment (SATA), integrated drive electronics (IDE), IEEE-1394, universal serial bus (USB), fiber channel, small computer systems interface (SCSI), etc. The memory drives may further include a drum, magnetic disc drive, magneto-optical drive, optical drive, redundant array of independent discs (RAID), solid-state memory devices, solid-state drives, etc.

Memory 730 may store a collection of program or database components, including, without limitation, an operating system 732, user interface application 734, web browser 736, mail server 738, mail client 740, user/application data 742 (for example, any data variables or data records discussed in this disclosure), etc. Operating system 732 may facilitate resource management and operation of computer system 702. Examples of operating systems 732 include, without limitation, APPLE® MACINTOSH® OS X platform, UNIX platform, Unix-like system distributions (for example, Berkeley Software Distribution (BSD), FreeBSD, NetBSD, OpenBSD, etc.), LINUX distributions (for example, RED HAT®, UBUNTU®, KUBUNTUS, etc.), IBM® OS/2 platform, MICROSOFT® WINDOWS® platform (XP, Vista/7/8, etc.), APPLE® IOSS platform, GOOGLE® ANDROID® platform, BLACKBERRY® OS platform, or the like. User interface 734 may facilitate display, execution, interaction, manipulation, or operation of program components through textual or graphical facilities. For example, user interfaces may provide computer interaction interface elements on a display system operatively connected to computer system 702, such as cursors, icons, check boxes, menus, scrollers, windows, widgets, etc. Graphical user interfaces (GUIs) may be employed, including, without limitation, APPLE® Macintosh® operating systems' AQUA® platform, IBMI OS/2® platform, MICROSOFT® WINDOWS) platform (for example, AERO® platform, METRO® platform, etc.), UNIX X-WINDOWS, web interface libraries (for example, ACTIVEX® platform, JAVA® programming language, JAVASCRIPT® programming language, AJAX® programming language, HTML, ADOBE® FLASH® platform, etc.), or the like.

In some embodiments, computer system 702 may implement a web browser 736 stored program component. Web browser 736 may be a hypertext viewing application, such as MICROSOFT® INTERNET EXPLORER® web browser, GOOGLE® CHROME® web browser, MOZILLA® FIREFOX® web browser, APPLE® SAFARI® web browser, etc. Secure web browsing may be provided using HTTPS (secure hypertext transport protocol), secure sockets layer (SSL), Transport Layer Security (TLS), etc. Web browsers may utilize facilities such as AJAX, DHTML, ADOBE® FLASH® platform, JAVASCRIPT® programming language, JAVAS programming language, application programming interfaces (APis), etc. In some embodiments, computer system 702 may implement a mail server 738 stored program component. Mail server 738 may be an Internet mail server such as MICROSOFT® EXCHANGE® mail server, or the like. Mail server 738 may utilize facilities such as ASP, ActiveX, ANSI C++/C #, MICROSOFT .NET® programming language, CGI scripts, JAVA® programming language, JAVASCRIPT® programming language, PERL® programming language, PHP® programming language, PYTHON® programming language, WebObjects, etc. Mail server 738 may utilize communication protocols such as internet message access protocol (IMAP), messaging application programming interface (MAPI), Microsoft Exchange, post office protocol (POP), simple mail transfer protocol (SMTP), or the like. In some embodiments, computer system 702 may implement a mail client 740 stored program component. Mail client 740 may be a mail viewing application, such as APPLE MAIL® mail client, MICROSOFT ENTOURAGE® mail client, MICROSOFT OUTLOOK® mail client, MOZILLA THUNDERBIRD® mail client, etc.

In some embodiments, computer system 702 may store user/application data 742, such as the data, variables, records, etc. as described in this disclosure. Such databases may be implemented as fault-tolerant, relational, scalable, secure databases such as ORACLE® database OR SYBASE® database. Alternatively, such databases may be implemented using standardized data structures, such as an array, hash, linked list, struct, structured text file (for example, XML), table, or as object-oriented databases (for example, using OBJECTSTORE® object database, POET® object database, ZOPE® object database, etc.). Such databases may be consolidated or distributed, sometimes among the various computer systems discussed above in this disclosure. It is to be understood that the structure and operation of the any computer or database component may be combined, consolidated, or distributed in any working combination.

It will be appreciated that, for clarity purposes, the above description has described embodiments of the invention with reference to different functional units and processors. However, it will be apparent that any suitable distribution of functionality between different functional units, processors or domains may be used without detracting from the invention. For example, functionality illustrated to be performed by separate processors or controllers may be performed by the same processor or controller. Hence, references to specific functional units are only to be seen as references to suitable means for providing the described functionality, rather than indicative of a strict logical or physical structure or organization.

Various embodiments provides method and system for implementing memory changes in digital Integrated Circuits (ICs). The method provides ease of use of the legacy designs by way of the use of memory wrappers, because the script-based tool of the system allows port names and memory names of the wrapper to be flexible. Moreover, the method may calculate the width and the depth requirement to analyze a new memory library and may accordingly select the best suited memory and create a memory wrapper. When exact width and depth are not available, the method may perform width split and depth split operations and may create the connections accordingly. For Flop based RAMs, the method may uses FPGA block RAMS for FPGA implementation and flop-based RAM for ASIC. Further, the method may integrate with memory cell generator tools of ASIC and FPGA. The proposed method reduces the time required to perform a memory changeoff within a digital IC design. Further, the method helps to reduce the manual effort and the workload, which further provides considerable cost reduction.

The specification has described system and method of implementing memory changes in digital ICs. The illustrated steps are set out to explain the exemplary embodiments shown, and it should be anticipated that ongoing technological development will change the manner in which particular functions are performed. These examples are presented herein for purposes of illustration, and not limitation. Further, the boundaries of the functional building blocks have been arbitrarily defined herein for the convenience of the description. Alternative boundaries can be defined so long as the specified functions and relationships thereof are appropriately performed. Alternatives (including equivalents, extensions, variations, deviations, etc., of those described herein) will be apparent to persons skilled in the relevant art(s) based on the teachings contained herein. Such alternatives fall within the scope and spirit of the disclosed embodiments.

Furthermore, one or more computer-readable storage media may be utilized in implementing embodiments consistent with the present disclosure. A computer-readable storage medium refers to any type of physical memory on which information or data readable by a processor may be stored. Thus, a computer-readable storage medium may store instructions for execution by one or more processors, including instructions for causing the processor(s) to perform steps or stages consistent with the embodiments described herein. The term “computer-readable medium” should be understood to include tangible items and exclude carrier waves and transient signals, i.e., be non-transitory. Examples include random access memory (RAM), read-only memory (ROM), volatile memory, nonvolatile memory, hard drives, CD ROMs, DVDs, flash drives, disks, and any other known physical storage media.

It is intended that the disclosure and examples be considered as exemplary only, with a true scope and spirit of disclosed embodiments being indicated by the following claims.

What is claimed is:

1. A method for implementing memory changes in digital Integrated Circuits (ICs), the method comprising:
generating a plurality of memory wrappers based on a first library associated with a digital IC design requirement and a second library associated with a set of available memories, wherein each of the plurality of memory wrappers is associated with a width and a depth requirement;
identifying at least one available memory from the set of available memories, for each of the plurality of memory wrappers, based on the associated width and depth requirement and width and depth details associated with each of the set of available memories, wherein the second library comprises the width and depth details associated with each of the set of available memories;
managing port connections for the at least one available memory associated with each of the plurality of memory wrappers, based on the first library and the second library; and
validating each of the plurality of memory wrappers using a testbench generated for the digital IC design.

2. The method of claim 1, wherein generating the plurality of memory wrappers comprises creating a mapping between the first library and the second library, wherein each of the first library and the second library comprises details of associated memory types, associated memory names, associated memory port names, associated memory port polarity, associated memory port functionality, associated memory widths and depths.

3. The method of claim 2, wherein creating the mapping between the first library and the second library comprises:
creating a first memory table comprising at least one of memory types, memory names, memory widths, and memory depths extracted from the first library; and
creating a second memory table comprising at least one of memory types, memory names, memory widths, and memory depths extracted from the second library.

4. The method of claim 2, wherein creating the mapping between the first library and the second library comprises:
creating a first port table comprising a mapping of a predefined port attribute names to corresponding port attributes extracted from the first library; and
creating a second port table comprising a mapping of the predefined port attribute names to corresponding port attributes extracted from the second library.

5. The method of claim 2, further comprising:
determining names for a plurality of memory wrappers using a rule created based on memory naming format used in the first library; and
generating, in a hardware description language, the plurality of memory wrappers based on the mapping between the first library and the second library and the names determined for each of the plurality of memory wrappers, wherein each of the plurality of memory wrappers comprises instantiation of at least one memory from the set of available memories.

6. The method of claim 1, further comprising generating a report in response to the validating, wherein the report comprises results of validating each of the plurality of memory wrappers.

7. The method of claim 1, wherein the digital IC comprises at least one of Application-Specific Integrated Circuit (ASIC) or Field Programmable Gate Array (FPGA).

8. The method of claim 1, wherein identifying the at least one available memory from the set of available memories for a memory wrapper of the plurality of memory wrappers comprises implementing at least one predefined width rule and at least one predefined depth rule on the set of available memories.

9. A method for generating memory wrappers for digital Integrated Circuits (ICs) designs, the method comprising:
creating a mapping between a first library associated with a digital IC design requirement and a second library associated with a set of available memories, wherein each of the first library and the second library comprises details of associated memory types, associated memory names, associated memory port names, associated memory port polarity, associated memory port functionality, associated memory widths and depths;
determining names for a plurality of memory wrappers using a rule created based on memory naming format used in the first library; and
generating, in a hardware description language, the plurality of memory wrappers based on the mapping between the first library and the second library and the names determined for each of the plurality of memory wrappers, wherein each of the plurality of memory wrappers comprises instantiation of at least one memory from the set of available memories.

10. The method of claim 9, wherein creating the mapping between the first library and the second library comprises:
creating a first memory table comprising at least one of memory types, memory names, memory widths, and memory depths extracted from the first library; and
creating a second memory table comprising at least one of memory types, memory names, memory widths, and memory depths extracted from the second library.

11. The method of claim 9, wherein creating the mapping between the first library and the second library comprises:
creating a first port table comprising a mapping of a predefined port attribute names to corresponding port attributes extracted from the first library; and
creating a second port table comprising a mapping of the predefined port attribute names to corresponding port attributes extracted from the second library.

12. The method of claim 9, wherein determining names for the plurality of memory wrappers comprises appending each memory name in the first library with an identifier, wherein the identifier enables an automated script to determine names for the plurality of memory wrappers.

13. A system for implementing memory changes in digital Integrated Circuits (ICs), the system comprising:
a processor; and
a memory communicatively coupled to the processor, wherein the memory stores processor instructions, which, on execution, causes the processor to:
generate a plurality of memory wrappers based on a first library associated with a digital IC design requirement and a second library associated with a set of available memories, wherein each of the plurality of memory wrappers is associated with a width and a depth requirement;
identify at least one available memory from the set of available memories, for each of the plurality of memory wrappers, based on the associated width and depth requirement and width and depth details associated with each of the set of available memories, wherein the second library comprises the width and depth details associated with each of the set of available memories;
manage port connections for the at least one available memory associated with each of the plurality of memory wrappers, based on the first library and the second library; and
validate each of the plurality of memory wrappers using a testbench generated for the digital IC design.

14. The system of claim 13, wherein generating the plurality of memory wrappers comprises creating a mapping between the first library and the second library, wherein each of the first library and the second library comprises details of associated memory types, associated memory names, associated memory port names, associated memory port polarity, associated memory port functionality, associated memory widths and depths.

15. The system of claim 14 wherein creating the mapping between the first library and the second library comprises:
creating a first memory table comprising at least one of memory types, memory names, memory widths, and memory depths extracted from the first library; and
creating a second memory table comprising at least one of memory types, memory names, memory widths, and memory depths extracted from the second library.

16. The system of claim 14 wherein creating the mapping between the first library and the second library comprises:
creating a first port table comprising a mapping of a predefined port attribute names to corresponding port attributes extracted from the first library; and
creating a second port table comprising a mapping of the predefined port attribute names to corresponding port attributes extracted from the second library.

17. The system of claim 13 further comprising:
determining names for a plurality of memory wrappers using a rule created based on memory naming format used in the first library; and
generating, in a hardware description language, the plurality of memory wrappers based on the mapping between the first library and the second library and the names determined for each of the plurality of memory wrappers, wherein each of the plurality of memory wrappers comprises instantiation of at least one memory from the set of available memories.

18. The system of claim 13 further comprising generating a report in response to the validating, wherein the report comprises results of validating each of the plurality of memory wrappers.

19. The system of claim 13, wherein the digital IC comprises at least one of Application-Specific Integrated Circuit (ASIC) or Field Programmable Gate Array (FPGA).

20. A system for generating memory wrappers for digital Integrated Circuits (ICs) designs, the system comprising:
a processor; and
a memory communicatively coupled to the processor, wherein the memory stores processor instructions, which, on execution, causes the processor to:
create a mapping between a first library associated with a digital IC design requirement and a second library associated with a set of available memories, wherein each of the first library and the second library comprises details of associated memory types, associated memory names, associated memory port names, associated memory port polarity, associated memory port functionality, associated memory widths and depths, wherein creating the mapping between the first library and the second library comprises:
creating a first memory table comprising at least one of memory types, memory names, memory widths, and memory depths extracted from the first library; and
creating a second memory table comprising at least one of memory types, memory names, memory widths, and memory depths extracted from the second library;
determine names for a plurality of memory wrappers using a rule created based on memory naming format used in the first library; and
generate, in a hardware description language, the plurality of memory wrappers based on the mapping between the first library and the second library and the names determined for each of the plurality of memory wrappers, wherein each of the plurality of memory wrappers comprises instantiation of at least one memory from the set of available memories.
